(19) United States
(12) Patent Application Publication
(10) Pub. No.: US 2016/0224168 A1
(43) Pub. Date: Aug. 4, 2016

(54) ELECTRONIC APPARATUS AND METHOD OF CONTROLLING ELECTRONIC APPARATUS

(71) Applicant: FUJIKURA LTD., Tokyo (JP)

(72) Inventors: Toshiaki WATANABE, Sakura-shi (JP); Osamu AOKI, Sakura-shi (JP); Yasuyuki TACHIKAWA, Sakura-shi (JP); Toshimizu TOMITSUKA, Sakura-shi (JP); Makoto TAKAMATSU, Sakura-shi (JP)

(73) Assignee: FUJIKURA LTD., Tokyo (JP)

(21) Appl. No.: 15/022,372

(22) PCT Filed: Sep. 12, 2014
(86) PCT No.: PCT/JP2014/074191

§ 371 Date: Mar. 16, 2016

(30) Foreign Application Priority Data
Sep. 17, 2013 (JP) 2013-191401

(51) Int. Cl. G06F 3/041; G06F 3/044

(52) U.S. Cl. CPC G06F 3/0414; G06F 3/044; G06F 3/0416; G06F 2203/04105; G06F 2203/04107

(57) ABSTRACT

An electronic apparatus (1) includes a touch panel (40), pressure-sensitive sensors (60), and a control device (90) which is connected to the touch panel (40) and the pressure-sensitive sensors (60). The control device (90) includes a touch panel control unit (91) which outputs a detection signal on the basis of an output value of the touch panel (40), a setting unit (94) which sets, as a reference value (OP₀), an output value (OPₙ) of the pressure-sensitive sensors (60) at a predetermined timing in a case where a detection signal is input from the touch panel control unit (91), and a first calculation unit (95) which calculates, as a first pressure (fₙ) of the pressure-sensitive sensor (60), a difference between an output value (OPₙ) of the pressure-sensitive sensor (60) after a predetermined timing and the reference value (OP₀). The setting unit (94) individually sets the reference value (OP₀) with respect to each of the pressure-sensitive sensors (60). The first calculation unit (95) individually calculates the first pressure (fₙ) with respect to each of the pressure-sensitive sensors (60) each time the output value of each of the pressure-sensitive sensors (60) is input.

### TECHNICAL FIELD

The present invention relates to an electronic apparatus including a display device, a touch panel, and a pressure-sensitive sensor, and a method of controlling the electronic apparatus.

For designated countries which permit the incorporation by reference, the contents described and/or illustrated in the documents relevant to Japanese Patent Application No. 2013-191401 filed on Sep. 17, 2013 will be incorporated herein by reference as a part of the description and/or drawings of the present application.

### BACKGROUND ART

It is known an electronic apparatus in which a touch panel is disposed on an upper side of a liquid crystal panel to detect an input position on a screen, and a pressure applied to the touch panel is detected by using a pressure-sensitive sensor (for example, refer to Patent Document 1).

### CITATION LIST

### Patent Document

Patent Document 1: JP 2010-244514 A

### SUMMARY OF THE INVENTION

### Problem to be Solved by the Invention

In the above-described electronic apparatus, the pressure-sensitive sensor is disposed at four corners of the touch panel, and the touch panel is supported to a housing through the pressure-sensitive sensor. Accordingly, there is a problem that detection accuracy of the four pressure-sensitive sensors varies depending on the posture of the electronic apparatus, and the like.

An object of the invention is to provide an electronic apparatus capable of improving pressure detection accuracy, and a method of controlling the electronic apparatus.

### Means for Solving Problem

[1] An electronic apparatus according to the present invention is an electronic apparatus comprising: a cover member including a transparent portion; a touch panel on which the cover member is laid; a display unit which includes a display region which faces the transparent portion through the touch panel; pressure-sensitive sensors which deform in accordance with pressing of the cover member; and a control unit which is electrically connected to the touch panel and the pressure-sensitive sensor. The control unit includes: a detection unit which outputs a detection signal on the basis of an output value of the touch panel; a setting unit which sets, as a reference value, an output value of the pressure-sensitive sensor at a predetermined timing in a case where the detection signal is input from the detection unit; and a first calculation unit which calculates, as a first pressure which is applied to the pressure-sensitive sensor, a difference between an output value of the pressure-sensitive sensor after the predetermined timing and the reference value. The setting unit individually sets the reference value with respect to each of the pressure-sensitive sensors. The first calculation unit individually calculates the first pressure with respect to each of the pressure-sensitive sensors each time the output value of each of the pressure-sensitive sensors is input. The detection signal is a signal which represents that contact of an object to be detected with the cover member is detected. The predetermined timing is a point of time immediately before detecting the contact of the object or a point of time at which the contact of the object is detected.

[2] An electronic apparatus according to the present invention is an electronic apparatus comprising: a cover member including a transparent portion; a touch panel on which the cover member is laid; a display unit which includes a display region which faces the transparent portion through the touch panel; pressure-sensitive sensors which deform in accordance with pressing of the cover member, and a control unit which is electrically connected to the touch panel and the pressure-sensitive sensor. The control unit includes: a detection unit which outputs a detection signal on the basis of an output value of the touch panel; a setting unit which sets, as a reference value, an output value of the pressure-sensitive sensor at a predetermined timing in a case where the detection signal is input from the detection unit; and a first calculation unit which calculates, as a first pressure which is applied to the pressure-sensitive sensor, a difference between an output value of the pressure-sensitive sensor after the predetermined timing and the reference value. The setting unit individually sets the reference value with respect to each of the pressure-sensitive sensors. The first calculation unit individually calculates the first pressure with respect to each of the pressure-sensitive sensors each time the output value of each of the pressure-sensitive sensors is input. The detection signal is a signal which represents that approaching of an object to be detected to the cover member in a predetermined distance is detected. The predetermined timing is a point of time at which the approaching of the object is detected or a point of time immediately after detecting the approaching of the object.

[3] An electronic apparatus according to the present invention is an electronic apparatus comprising: a cover member including a transparent portion; a touch panel on which the cover member is laid; a display unit which includes a display region which faces the transparent portion through the touch panel; pressure-sensitive sensors which deform in accordance with pressing of the cover member; and a control unit which is electrically connected to the touch panel and the pressure-sensitive sensor. The control unit includes: a detection unit which outputs a detection signal on the basis of an output value of the touch panel; a setting unit which sets, as a reference value, an output value of the pressure-sensitive sensor at a predetermined timing in a case where the detection signal is input from the detection unit; and a first calculation unit which calculates, as a first pressure which is applied to the pressure-sensitive sensor, a difference between an output value of the pressure-sensitive sensor after the predetermined timing and the reference value. The setting unit individually sets the reference value with respect to each of the pressure-sensitive sensors. The first calculation unit individually calculates the first pressure with respect to each of the pressure-sensitive sensors each time the output value of each of the pressure-sensitive sensors is input. The control unit further includes: a selection unit which selects, as a comparison value, any one of the reference values; and a correction unit which corrects the first pressure on the basis of the comparison value and the reference value.

[4] The control unit may further include a second calculation unit which calculates, as a second pressure which is applied to the cover member, the sum of the first pressures.

[5] A method of controlling an electronic apparatus according to the present invention is a method of controlling an electronic apparatus including a cover member including a transparent portion, a touch panel on which the cover member is laid, a display unit which includes a display region which faces the transparent portion through the touch panel, and pressure-sensitive sensors which deform in accordance with pressing of the cover member. The method comprises: a first step of detecting contact of an object to be detected with the cover member or approaching of the object to the cover member on the basis of an output value of the touch panel; a second step of setting, as a reference value, an output value of the pressure-sensitive sensor at a predetermined timing in a case where the contact or the approaching of the object is detected; and a third step of calculating, as a first pressure which is applied to the pressure-sensitive sensor, a difference between an output value of the pressure-sensitive sensor after the predetermined timing and the reference value. The second step includes individually setting the reference value with respect to each of the pressure-sensitive sensors. The third step includes individually calculating the first pressure with respect to the pressure-sensitive sensors each time the output value of each of the pressure-sensitive sensors is input. The first step includes detecting the contact of the object with the cover member. The predetermined timing is a point of time immediately before detecting the contact of the object, or a point of time at which the contact of the object is detected.

[6] A method of controlling an electronic apparatus according to the present invention is a method of controlling an electronic apparatus including a cover member including a transparent portion, a touch panel on which the cover member is laid, a display unit which includes a display region which faces the transparent portion through the touch panel, and pressure-sensitive sensors which deform in accordance with pressing of the cover member. The method comprises: a first step of detecting contact of an object to be detected with the cover member or approaching of the object to the cover member on the basis of an output value of the touch panel; a second step of setting, as a reference value, an output value of the pressure-sensitive sensor at a predetermined timing in a case where the contact or the approaching of the object is detected; and a third step of calculating, as a first pressure which is applied to the pressure-sensitive sensor, a difference between an output value of the pressure-sensitive sensor after the predetermined timing and the reference value. The second step includes individually setting the reference value with respect to each of the pressure-sensitive sensors. The third step includes individually calculating the first pressure with respect to each of the pressure-sensitive sensors each time the output value of each of the pressure-sensitive sensors is input. The first step includes detecting the approaching of the object to the cover member in a predetermined distance. The predetermined timing is a point of time at which the approaching of the object is detected or a point of time immediately after detecting the approaching of the object.

[7] A method of controlling an electronic apparatus according to the present invention is a method of controlling an electronic apparatus including a cover member including a transparent portion, a touch panel on which the cover member is laid, a display unit which includes a display region which faces the transparent portion through the touch panel, and pressure-sensitive sensors which deform in accordance with pressing of the cover member. The method comprises: a first step of detecting contact of an object to be detected with the cover member or approaching of the object to the cover member on the basis of an output value of the touch panel; a second step of setting, as a reference value, an output value of the pressure-sensitive sensor at a predetermined timing in a case where the contact or the approaching of the object is detected; and a third step of calculating, as a first pressure which is applied to the pressure-sensitive sensor, a difference between an output value of the pressure-sensitive sensor after the predetermined timing and the reference value. The second step includes individually setting the reference value with respect to each of the pressure-sensitive sensors. The third step includes individually calculating the first pressure with respect to each of the pressure-sensitive sensors each time the output value of each of the pressure-sensitive sensors is input. The method further includes: a fourth step of selecting, as a comparison value, any one of the reference values; and a fifth step of correcting the first pressure on the basis of the comparison value and the reference value.

[8] The method of controlling an electronic apparatus may further include a sixth step of calculating, as a second pressure which is applied to the cover member, the sum of the first pressures.

### Effect of the Invention

According to the invention, since the difference between the output value of the pressure-sensitive sensor and the reference value is calculated as the first pressure, it is possible to cancel an effect due to the posture of the electronic apparatus and the like, and it is possible to realize an improvement in pressure detection accuracy by the pressure-sensitive sensor.

### BRIEF DESCRIPTION OF DRAWINGS

FIG. 1 is a plan view of an electronic apparatus in an embodiment of the invention;

FIG. 2 is a cross-sectional view taken along line II-II in FIG. 1;

FIG. 3 is a plan view of a cover member in the embodiment of the invention.

FIG. 4 is a bottom view of a reinforcing member in the embodiment of the invention;

FIG. 5 is an exploded perspective view of a touch panel in the embodiment of the invention;

FIG. 6 is a plan view of a display device in the embodiment of the invention;

FIG. 7 is a cross-sectional view of a pressure-sensitive sensor in the embodiment of the invention;

FIG. 8 is a plan view illustrating arrangement of the pressure-sensitive sensor on a support member in the embodiment of the invention;

FIG. 9 is a block diagram illustrating a control device of an electronic apparatus in the embodiment of the invention;

FIG. 10 is a circuit diagram illustrating an acquisition unit in the embodiment of the invention;

FIG. 11 is a circuit diagram illustrating a first modification example of the acquisition unit in the embodiment of the invention;

FIG. 12 is a circuit diagram illustrating a second modification example of the acquisition unit in the embodiment of the invention;

FIG. 13 is a view illustrating a pressure-output characteristics of the pressure-sensitive sensor; and

FIG. 14 is a flowchart illustrating a method of detecting a pressure in the embodiment of the invention.

### MODE FOR CARRYING OUT THE INVENTION

Hereinafter, an embodiment of the invention will be described with reference to the accompanying drawings.

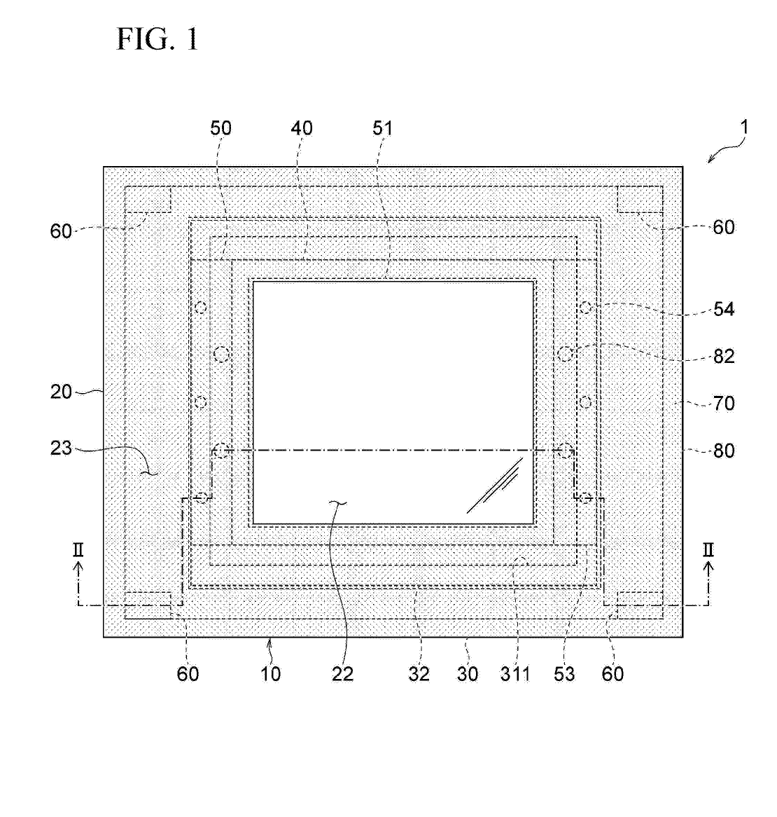

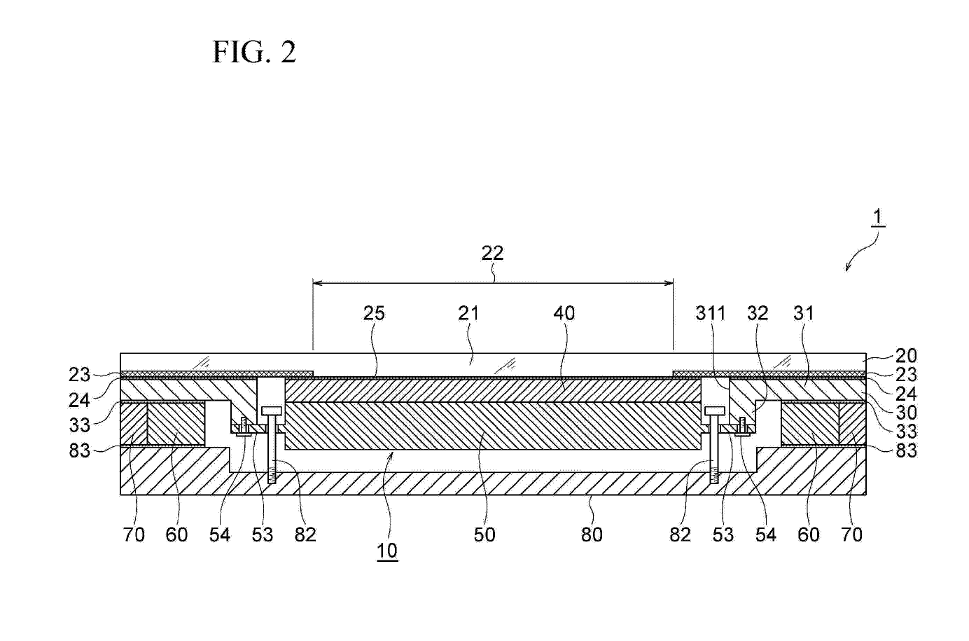

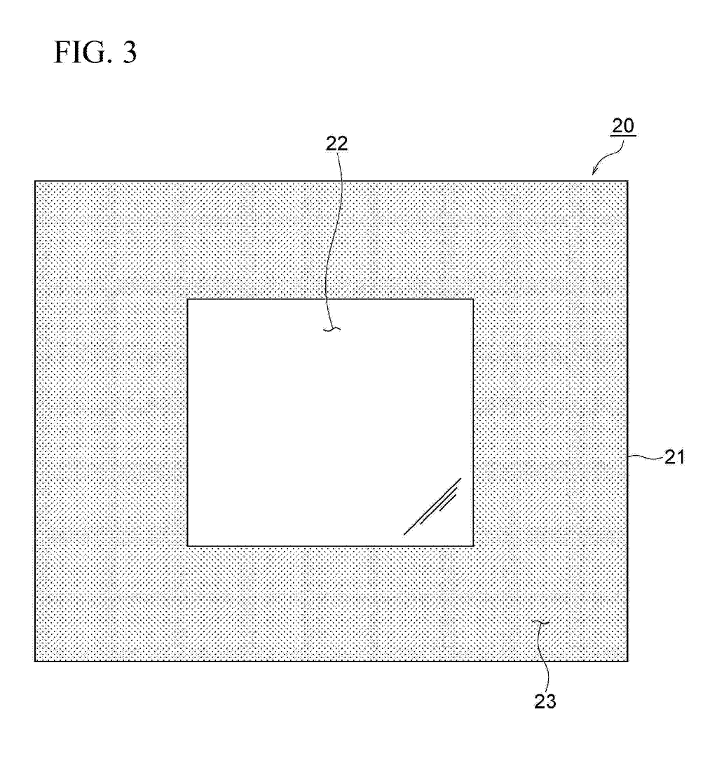

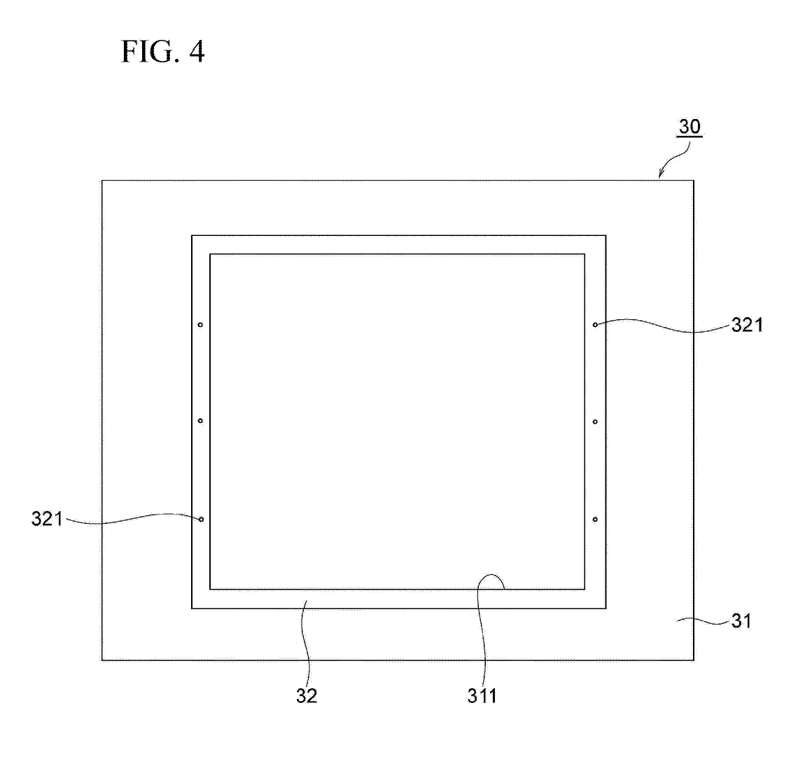

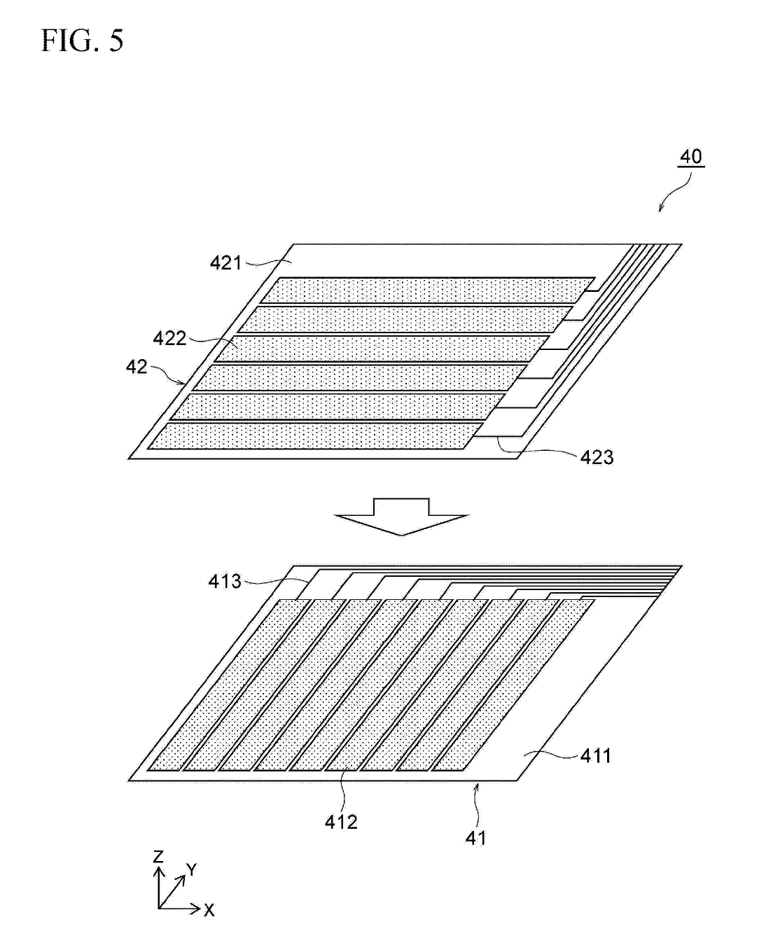

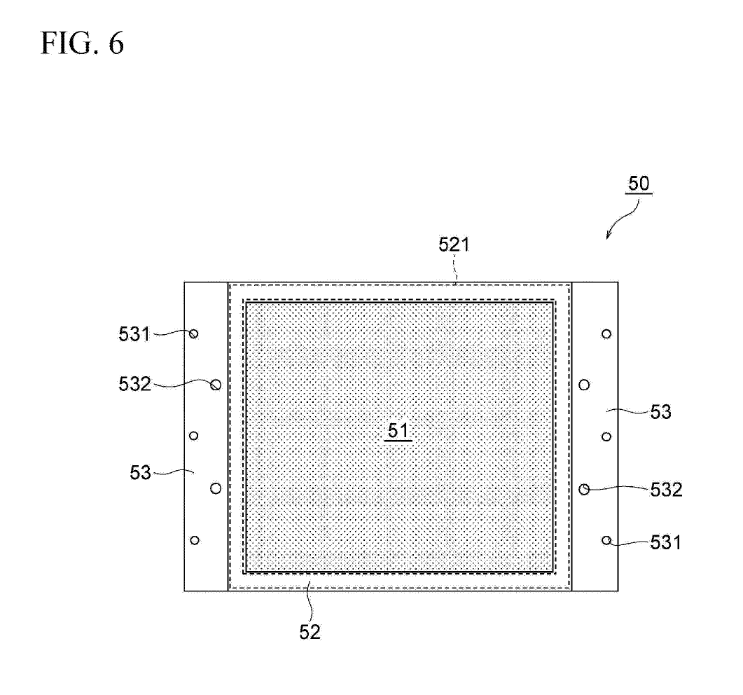

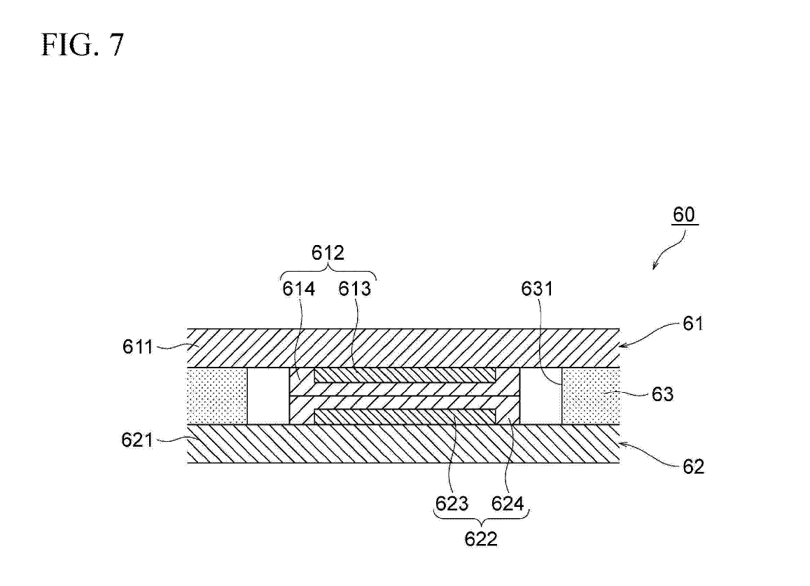

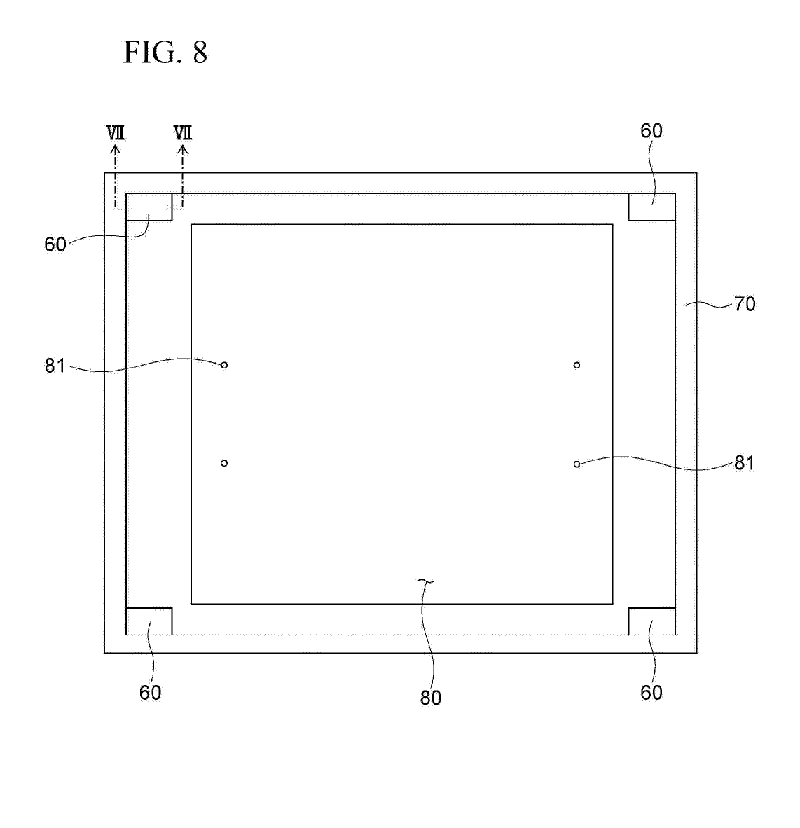

FIG. 1 and FIG. 2 are a plan view and a cross-sectional view of an electronic apparatus in a first embodiment of the invention, FIG. 3 is a plan view of a cover member, FIG. 4 is a bottom view of a reinforcing member, FIG. 5 is an exploded perspective view of a touch panel, FIG. 6 is a plan view of a display device, FIG. 7 is a cross-sectional view of a pressure-sensitive sensor, and FIG. 8 is a plan view illustrating arrangement of the pressure-sensitive sensor on a support member.

As illustrated in FIG. 1 and FIG. 2, an electronic apparatus 1 in the present embodiment includes a movable unit 10, a pressure-sensitive sensor 60, a seal member 70, and a support member 80. The movable unit 10 includes a cover member 20, a reinforcing member 30, a touch panel 40, and a display device 50. The movable unit 10 is supported to the support member 80 through the pressure-sensitive sensor 60 and the seal member 70, and a minute vertical movement of the movable unit 10 with respect to the support member 80 is permitted due to an elastic deformation of the pressure-sensitive sensor 60 and the seal member 70.

The electronic apparatus 1 can display an image by the display device 50 (display function). In addition, in a case where an arbitrary position on the cover member 20 is indicated by a finger of an operator, a touch pen, and the like, the electronic apparatus 1 can detect XY coordinates of the position with the touch panel 40 (position input function). In addition, in a case where the movable unit 10 is pressed with a finger of the operator and the like, the electronic apparatus 1 can detect the pressing operation with the pressure-sensitive sensor 60.

As illustrated in FIG. 2 and FIG. 3, the cover member 20 is constituted by a transparent substrate 21 through which visible light beams can be transmitted. Specific examples of a material of which the transparent substrate 21 is made include glass, polymetylmethacrylate (PMMA), polycarbonate (PC), and the like.

For example, a shielding portion (bezel portion) 23, which is formed by applying white ink, black ink, and the like, is provided on a lower surface of the transparent substrate 21. The shielding portion 23 is formed in a frame shape in a region on the lower surface of the transparent substrate 21 except for a rectangular transparent portion 22 which is located at the center of the lower surface. The shapes of the transparent portion 22 and the shielding portion 23 are not particularly limited to the above-described shapes. A decorating member which is decorated with a white color or a black color may be laminated on a lower surface of the transparent substrate 21 so as to form the shielding portion 23. Alternatively, a transparent sheet, which has substantially the same size as the transparent substrate 21 and in which only a portion corresponding to the shielding portion 23 is colored with a white color or a black color, may be prepared, and the sheet may be laminated on the lower surface of the transparent substrate 21 so as to form the shielding portion 23.

As illustrated in FIG. 2 and FIG. 4, the reinforcing member 30 is a frame-shaped member that is fixed to the lower surface of the cover member 20 through a gluing agent 24. The reinforcing member 30 is attached to the shielding portion 23 of the cover member 20, and the reinforcing member 30 is not visually recognized to the operator. In the present embodiment, an adhesive may be used instead of the gluing agent 24, 25, 33, or 83.

The reinforcing member 30 includes a main body portion 31 and a protruding portion 32. The main body portion 31 has a rectangular frame shape, and extends in a direction which is substantially parallel to a main surface of the cover member 20. On the other hand, the protruding portion 32 has a square tubular shape which communicates with an opening 311 of the main body portion 31, and protrudes from an inner edge of the main body portion 31 toward a lower side. A screw hole 321 for screwing of the display device 50 is formed in a tip end surface of the protruding portion 32. The reinforcing member 30 is made of a material which is hard and excellent in workability, for example, a metallic material such as stainless steel (SUS), a resin material such as an ABS resin or polycarbonate (PC), and a composite material such as fiber reinforced plastic (FRP). The main body portion 31 and the protruding portion 32 are integrally formed.

As illustrated in FIG. 5, the touch panel 40 is an electrostatic capacitance type touch panel including two electrode sheets 41 and 42 which overlap each other. The structure of the touch panel is not particularly limited thereto, and for example, a resistive film type touch panel or an electromagnetic induction type touch panel may be employed. The following first electrode pattern 412 or second electrode pattern 422 may be formed on the lower surface of the cover member 20, and the cover member 20 may be used as a part of the touch panel. Alternatively, a sheet, in which an electrode is formed on both surfaces thereof, may be used instead of the two electrode sheets 41 and 42.

The first electrode sheet 41 includes a first transparent substrate 411 through which visible light beams can be transmitted, and first electrode patterns 412 which are provided on the first transparent base material 411.

Specific examples of a material of which the first transparent substrate 411 is made include resin materials such as polyethylene terephthalate (PET), polyethylene naphthalate (PEN), polyethylene (PE), polypropylene (PP), polystyrene (PS), an ethylene-vinyl acetate copolymer resin (EVA), vinyl resin, polycarbonate (PC), polyamide (PA), polyimide (PI), polyvinyl alcohol (PVA), an acrylic resin, and triacetyl cellulose (TAC).

For example, the first electrode patterns 412 are transparent electrodes which are made of indium tin oxide (ITO) or a conductive polymer, and are configured as strip-like face patterns (so-called solid patterns) which extend in a Y direction in FIG. 5. In an example illustrated in FIG. 5, nine first electrode patterns 412 are arranged in parallel on the first transparent substrate 411. The shape, the number, the arrangement, and the like of the first electrode patterns 412 are not particularly limited to the above-described configurations.

In the case where the first electrode patterns 412 is made of ITO, for example, the first electrode patterns 412 are formed through sputtering, photolithography, and etching. On the other hand, in the case where the first electrode patterns 412 is made of a conductive polymer, the first electrode patterns 412 can be formed through sputtering and the like similar to the case of ITO, or can be formed through a printing method such as screen printing and gravure-offset printing, or through etching after coating.

Specific examples of the conductive polymer of which the first electrode patterns 412 is made include organic compounds such as a polythiophene-based compound, a polypyrrole-based compound, a polyaniline-based compound, a polyacetylene-based compound, and a polyphenylene-based compound. A PEDOT/PSS compound is preferably used among these compounds.

Furthermore, the first electrode patterns 412 may be formed by printing conductive paste on the first transparent substrate 411 and by curing the conductive paste. In this case, each of the first electrode patterns 412 is formed in a mesh shape instead of the face pattern so as to secure sufficient light transmittance of the touch panel 30. As the conductive paste, for example, conductive paste, which is obtained by mixing metal particles such as silver (Ag) and copper (Cu), and a binder such as polyester and polyphenol, can be used.

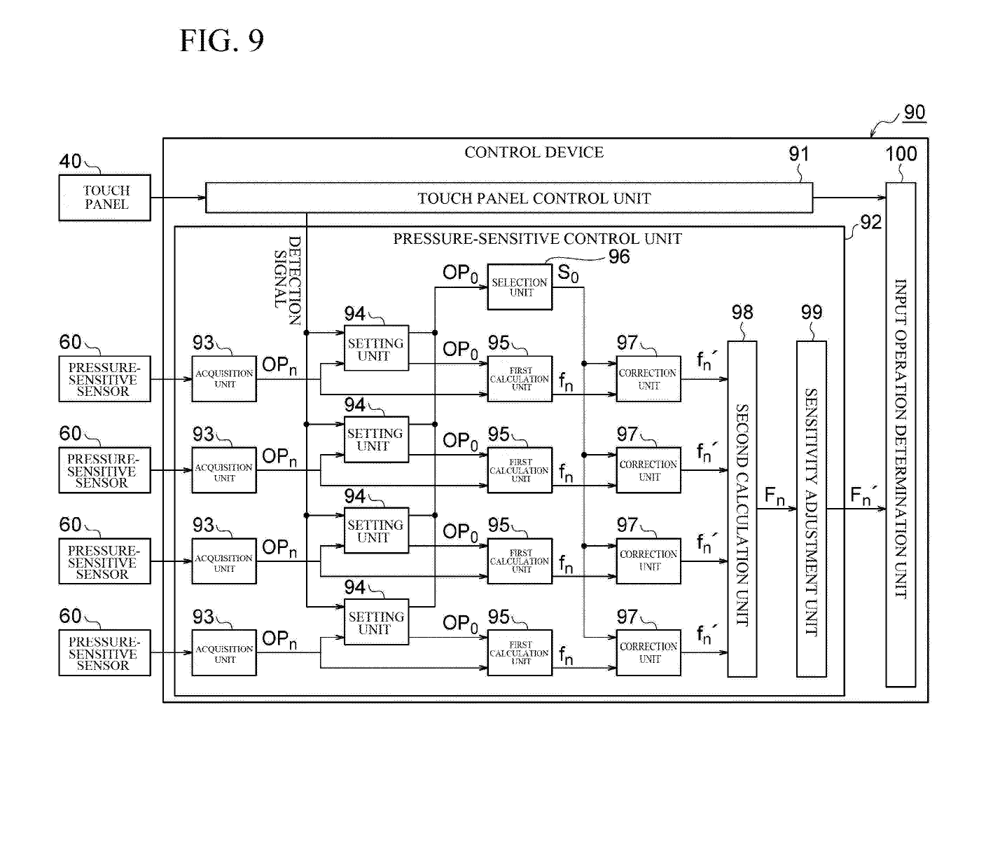

The first electrode patterns 412 are connected to a touch panel control unit 91 (see FIG. 9) through a first lead-out wiring pattern 413. The first lead-out wiring pattern 413 is provided at a position, which faces the shielding portion 23 of the cover member 20, on the first transparent substrate 411, and the first lead-out wiring pattern 413 is not visually recognized to the operator. Therefore, the first lead-out wiring pattern 413 is formed by printing conductive paste on the first transparent substrate 411 and by curing the conductive paste.

The second electrode sheet 42 also includes a second transparent substrate 421 through which visible light beams can be transmitted, and second electrode patterns 422 which are provided on the second transparent substrate 421.

The second transparent substrate 421 is made of the same material as in the above-described first transparent substrate 411. Similar to the above-described first electrode patterns 412, the second electrode patterns 422 are also transparent electrodes which are made of, for example, indium tin oxide (ITO) or a conductive polymer.

The second electrode patterns 422 are configured as rectangular face patterns which extend in an X direction in FIG. 5. In an example illustrated in FIG. 5, six second electrode patterns 422 are arranged in parallel on the second transparent substrate 421. The shape, the number, the arrangement, and the like of the second electrode patterns 422 are not particularly limited to the above-described configurations.

The second electrode patterns 422 are connected to the touch panel control unit 91 (see FIG. 9) through a second lead-out wiring pattern 423. The second lead-out wiring pattern 423 is provided at a position, which faces the shielding portion 23 of the cover member 20, on the second transparent substrate 421, and the second lead-out wiring pattern 423 is not visually recognized to the operator. Therefore, similar to the above-described first lead-out wiring pattern 413, the second lead-out wiring pattern 423 is also formed by printing conductive paste on the second transparent substrate 421 and by curing the conductive paste.

The first electrode sheet 41 and the second electrode sheet 42 are attached to each other through a transparent gluing agent in such a manner that the first electrode patterns 412 and the second electrode patterns 422 are substantially orthogonal to each other in a plan view. The touch panel 40 itself is attached to the lower surface of the cover member 20 through the transparent gluing agent 25 in such a manner that the first and second electrode patterns 412 and 422 face the transparent portion 22 of the cover member 20. Specific examples of the transparent gluing agent 25 include an acryl-based gluing agent, and the like.

As illustrated in FIG. 6, the display device 50 includes a display region 51 on which an image is displayed, an outer edge region 52 which surrounds the display region 51, and a flange 53 which protrudes from both ends of the outer edge region 52. For example, the display region 51 of the display device 50 is constituted by a thin type display device such as a liquid crystal display, an organic EL display, or an electronic paper.

Two kinds of through-holes 531 and 532 are formed in the flange portion 53. Each of the first through-holes 531 faces each of screw holes 321 which is formed in the protruding portion 32 of the reinforcing member 30. On the other hand, each of the second through-holes 532 faces each of screw holes 81 (to be described later) of the support member 80.

As illustrated in FIG. 2, when a bolt 54 screwed into the screw hole 321 through the first through-hole 531, the display device 50 is fixed to the reinforcing member 30. According to this, the display region 51 faces the transparent portion 22 of the cover member 20 through the opening 311 of the reinforcing member 30.

In the present embodiment, when the bolt 54 is fastened to the reinforcing member 30, the outer edge region 52 of the display device 50 is brought into close contact with a lower surface of the touch panel 40, and thus the touch panel 40 is interposed between the cover portion 20 and the display device 50. According to this, a gap between the touch panel 40 and the display device 50 is not present, and thus appearance of a screen in the electronic apparatus 1 is improved.

In addition, in the present embodiment, since the touch panel 40 and the display device 50 can be brought into close contact with each other without using a gluing agent, there is no concern that foreign matter or air bubbles are trapped between the touch panel 40 and the display device 50, and thus a yield ratio of a product is improved.

The outer edge region 52 and the touch panel 40 may be fixed to each other by applying the gluing agent (a broken line portion 521 in FIG. 6) only to the outer edge region 52. According to this, it is possible to enhance the rigidity of the movable unit 10, and thus it is possible to make the elements 20 to 50 of the movable unit 10 thin. As a result, it is possible to make the entirety of the movable unit 10 thin. An adhesive may be used instead of the gluing agent 521.

As illustrated in FIG. 1 and FIG. 2, the pressure-sensitive sensors 60 are attached to four corners of the above-described movable unit 10. The number and the arrangement of the pressure-sensitive sensor 60 are not particularly limited as long as the pressure-sensitive sensors 60 can stably hold the movable unit 10. The configuration of the pressure-sensitive sensor is not limited to the following configuration as long as a pressure can be detected. For example, an electrostatic capacitance type sensor, a pressure-sensitive conductive rubber, a strain gauge, a piezoelectric element, and the like may be used as the pressure-sensitive sensor.

As illustrated in FIG. 7, each of the pressure-sensitive sensors 60 includes a first electrode sheet 61, a second electrode sheet 62, and a spacer 63 which is interposed therebetween. FIG. 7 is a cross-sectional view taken along line VII-VII in FIG. 8 to be described later.

The first electrode sheet 61 includes a first substrate 611 and an upper electrode 612. The first substrate 611 is a flexible insulating film, and is made of, for example, polyethylene terephthalate (PET), polyethylene naphthalate (PEN), polyimide (PI), polyetherimide (PEI), and the like.

The upper electrode 612 includes a first upper electrode layer 613 and a second upper electrode layer 614, and is provided on a lower surface of the first substrate 611. The first upper electrode layer 613 is formed by printing conductive paste, which has a relative low electric resistance, on the lower surface of the first substrate 611, and by curing the conductive paste. On the other hand, the second upper electrode layer 614 is formed by printing conductive paste, which has a relatively high electric resistance, on the lower surface of the first substrate 611 so as to cover the first upper electrode layer 613, and by curing the conductive paste.

The second electrode sheet 62 also includes a second substrate 621 and a lower electrode 622. The second substrate 621 is made of the same material as in the above-described first substrate 611. The lower electrode 622 includes a first lower electrode layer 623 and a second lower electrode layer 624, and is provided on an upper surface of the second substrate 621.

Similar to the above-described first upper electrode layer 613, the first lower electrode layer 623 is formed by printing conductive paste, which has a relatively low electric resistance, on an upper surface of the second substrate 621, and by curing the conductive paste. On the other hand, similar to the above-described second upper electrode layer 614, the second lower electrode layer 624 is formed by printing conductive paste, which has a relatively high electric resistance, on the upper surface of the second substrate 621 so as to cover the first lower electrode layer 623, and by curing the conductive paste.

Examples of the conductive paste, which has a relatively low electric resistance, include silver (Ag) paste, gold (Au) paste, and copper (Cu) paste. In contrast, examples of the conductive past, which has a relatively high electric resistance, include carbon (C) paste. Examples of a method of printing the conductive paste include screen printing, gravure-offset printing, an inkjet method, and the like.

The first electrode sheet 61 and the second electrode sheet 62 are laminated through the spacer 63. The spacer 63 is made of an insulating material such as polyethylene terephthalate (PET), polyethylene naphthalate (PEN), polyimide (PI), and polyetherimide (PEI).

An opening 631 is formed in the spacer 63 at a position which corresponds to the upper electrode 612 and the lower electrode 622. The upper electrode 612 and the lower electrode 622 are located inside the opening 631 and face each other. The thickness of the spacer 63 is set so that the upper electrode 612 and the lower electrode 622 come into contact with each other. The upper electrode 612 and the lower electrode 622 may not come into contact with each other. However, when the upper electrode 612 and the lower electrode 622 are brought into contact with each other in advance, a problem, in which the electrodes do not contact with each other even when a pressure is applied (that is, an output of the pressure-sensitive sensor 60 is zero (0)), does not occur, and thus it is possible to realize an improvement in detection accuracy.

The second upper electrode layer 614 or the second lower electrode layer 624 may be formed by printing pressure-sensitive ink instead of the carbon paste, and by curing the pressure-sensitive ink. The electrode layers 613, 614, 623, and 624 can be formed through a plating process or a patterning process instead of the printing method.

The support member 80 supports the movable unit 10 through the pressure-sensitive sensor 60, and is made of, for example, a metallic material such as aluminum, or a resin material such as polycarbonate (PC) or an ABS resin. As described above, the pressure-sensitive sensors 60 are disposed at four corners of the support member 80. As illustrated in FIG. 8, the seal member 70 is provided on the support member 80 along an outer edge of the support member 80 to be located on an outer side of the pressure-sensitive sensor 60. Although not particularly illustrated in the drawings, the pressure-sensitive sensors 60 may be disposed between the lower surface of the display device 50 and the upper surface of the support member 80.

The annular seal member 70 is made of a material which has a compressive elasticity modulus which is relatively lower than that of the pressure-sensitive sensor, and has a sealing property. Specific examples of the material of which the seal member 70 made of include urethane foam having closed cells, and the like. The seal member 70 prevents foreign matter from intruding into a space between the movable unit 10 and the support member 80 from an outer side.

As illustrated in FIG. 2, the pressure-sensitive sensors 60 and the seal member 70 are attached to a lower surface of the main body portion 31 of the reinforcing member 30 through the gluing agent 33, and are attached to the support member 80 through the gluing agent 83. All of the pressure-sensitive sensors 60 and the seal member 70 are disposed on a rear side of the shielding portion 23 of the cover member 20, and thus the pressure-sensitive sensors 60 and the seal member 70 are not visually recognized to the operator.

As illustrated in FIG. 2, FIG. 6, and FIG. 8, two screw holes 81 are formed in an upper surface of the support member 80 to face the second through-hole 532 in the flange 53 of the display device 50. Bolts 82 are respectively fixed to the screw holes 81 through the second through-holes 532 of the display device 50.

Each of the bolt 82 has a head portion having an outer diameter which is greater than an inner diameter of the second through-hole 532 of the display device 50, and a shaft portion having an outer diameter which is smaller than the inner diameter of the second through-hole 532. By the bolts 82, the movable unit 10 is restricted from being spaced away from the support member 80 in a predetermined distance or greater while being permitted to slightly move in a vertical direction. According to this, for example, in the case of inverting the electronic apparatus 1, the movable unit 10 is prevented from being separated from the support member 80.

Next, description will be given of a control system of an electronic apparatus in the present embodiment with reference to FIG. 9 to FIG. 13.

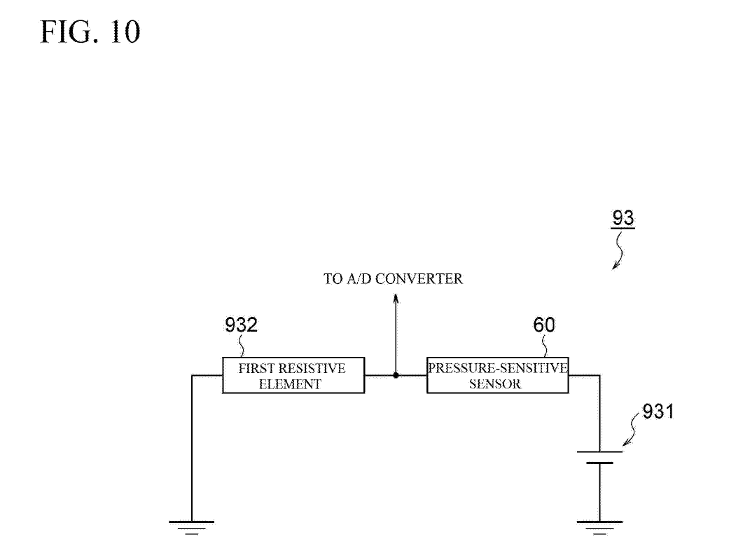

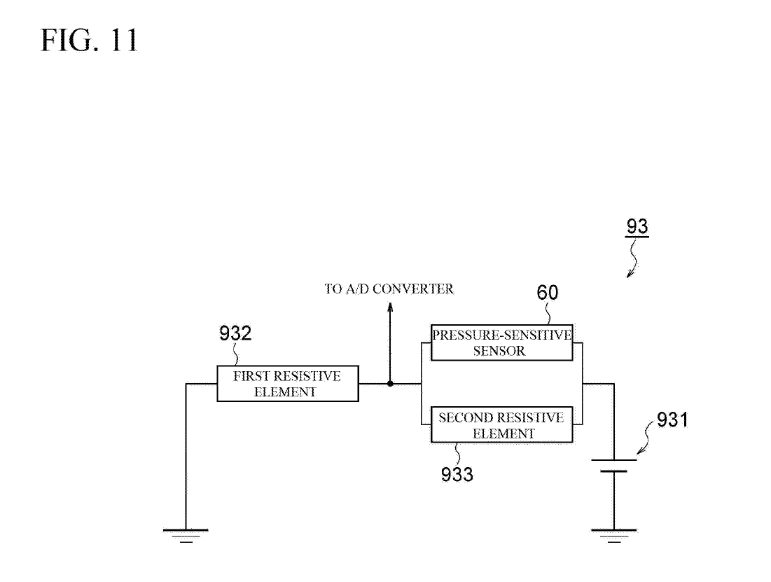

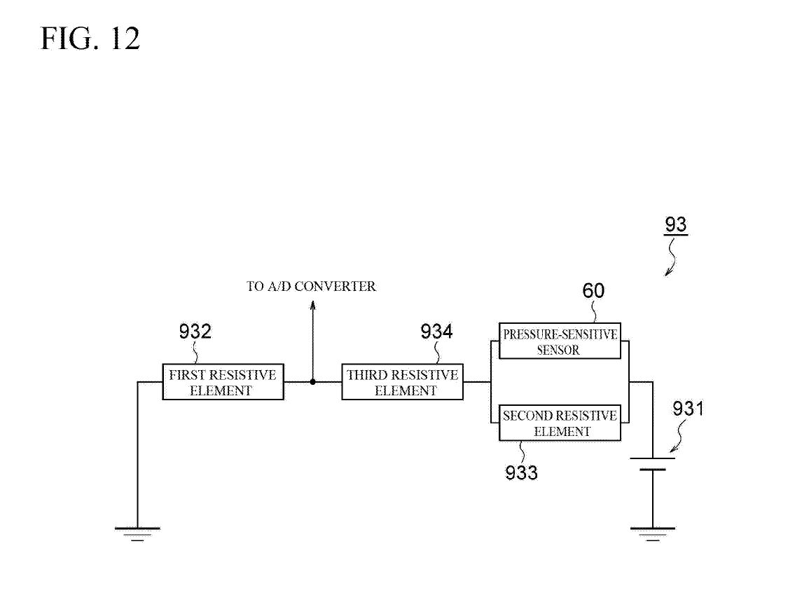

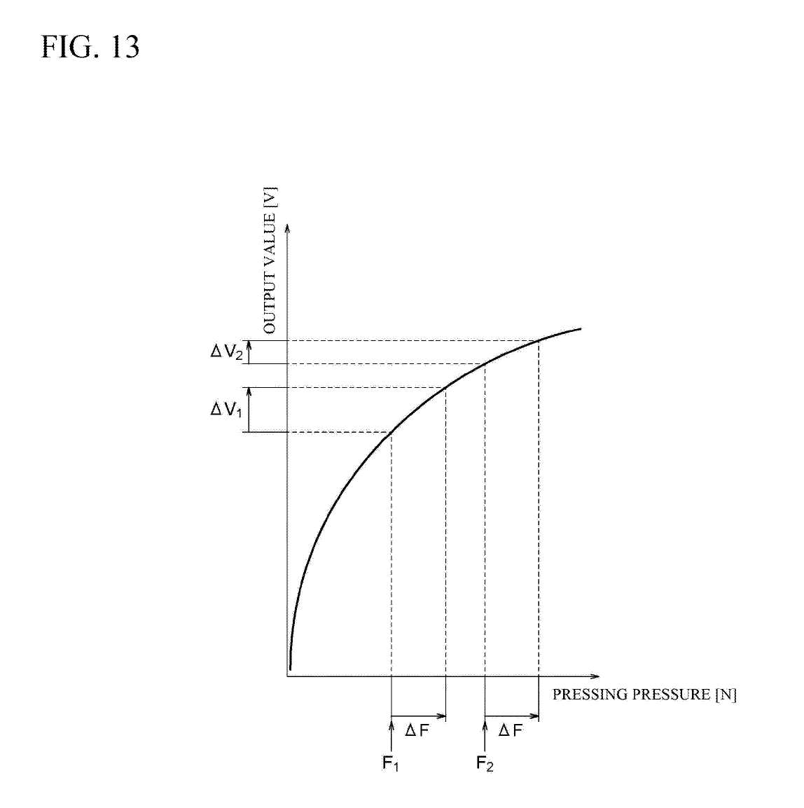

FIG. 9 is a block diagram illustrating a control device of the electronic apparatus in the present embodiment, and FIG. 10 is a circuit diagram illustrating an acquisition unit in the present embodiment, FIG. 11 and FIG. 12 are circuit diagrams illustrating a modification example of the acquisition unit in the present embodiment, and FIG. 13 is a view illustrating pressure-output characteristics of the pressure-sensitive sensor.

For example, a control device 90 of the electronic apparatus 1 in the present embodiment is constituted by a computer including a CPU, a ROM, a RAM, various interfaces, and the like, an electric circuit, and the like, and is electrically connected to the touch panel 30 and the pressure-sensitive sensor 60. As illustrated in FIG. 9, the control device 90 functionally includes a touch panel control unit 91 which controls the touch panel 30, a pressure-sensitive sensor control unit 92 which controls the pressure-sensitive sensor 60, and an input operation determination unit 100 which determines an input operation to the electronic apparatus 1 on the basis of an output of the control units 91 and 92. The control device 90 in the present embodiment corresponds to an example of a control unit in the present invention, and the touch panel control unit 91 in the present embodiment corresponds to an example of a detection unit in the present invention.

For example, the touch panel control unit 91 periodically applies a predetermined voltage between the first electrode patterns 412 and the second electrode patterns 422 of the touch panel 40, and detects a position of a finger on the touch panel 40 on the basis of a variation in electrostatic capacitance at each intersection between the first and second electrode patterns 412 and 422.

In the present example, when a value of the electrostatic capacitance reaches a predetermined threshold value or greater, the touch panel control unit 91 detects that a finger of the operator comes into contact with the cover member 20, and a detection signal is output to the pressure-sensitive sensor control unit 92.

When the touch panel control unit 91 detects that the finger of the operator approaches the cover member 20 in a predetermined distance (a so-called hover state), a detection signal may be output to the pressure-sensitive sensor control unit 92.

As illustrated in FIG. 9, the pressure-sensitive sensor control unit 92 includes an acquisition unit 93, a setting unit 94, a first calculation unit 95, a selection unit 96, a correction unit 97, a second calculation unit 98, and a sensitivity adjustment unit 99.

As illustrated in FIG. 10, the acquisition unit 93 includes a power supply 931 which is connected in series to the upper electrode 612 (or the lower electrode 622) of the pressure-sensitive sensor 60, and a first resistive element 932 which is connected in series to the lower electrode 622 (or the upper electrode 612) of the pressure-sensitive sensor 60. In a state in which a predetermined voltage is applied between the electrodes 612 and 622 by the power supply 931, when a load from an upper side to the pressure-sensitive sensor 60 increases, an electrical resistance value between the electrodes 612 and 622 varies in accordance with the size of the load. The acquisition unit 93 periodically samples a voltage value, which corresponds to the resistance variation, from the pressure-sensitive sensor 60 at a constant interval, converts the voltage value into a digital signal with an A/D converter, and outputs the digital signal to the setting unit 94 and the first calculation unit 95.

As illustrated in FIG. 11, the acquisition unit 93 may include a second resistive element 933 which is connected in parallel to the pressure-sensitive sensor 60. In addition, as illustrated in FIG. 12, the acquisition unit 93 may include a third resistive element 934 which is connected in series to a parallel circuit which is constituted by the pressure-sensitive sensor 60 and the second resistive element 933. An output characteristic of the pressure-sensitive sensor 60 can be made to be close to a linear shape by adjusting the resistance value of the first to third resistive elements 932 to 934.

When the detection signal is input from the touch panel control unit 91, the setting unit 94 sets, as a reference value OP₀, an output value OPₙ of the pressure-sensitive sensor 60 at a predetermined timing. The setting unit 94 is provided for each pressure-sensitive sensor 60, and sets the reference value OP₀ for each pressure-sensitive sensor 60. The reference value OP₀ also includes 0 (zero).

In a case where the detection signal indicates that contact of the finger with the cover member 20 is detected, the setting unit 94 sets, as the reference value OP₀, an output value of the pressure-sensitive sensor 60 immediately before detecting the contact (that is, an output value OPₙ which is sampled immediately before detecting the contact).

In contrast, when the detection signal represents that approaching of the finger to the cover member 20 in a predetermined distance is detected, the setting unit 94 sets, as the reference value OP₀, an output value of the pressure-sensitive sensor 60 immediately after the detection of the approaching (that is, an output value OPₙ which is sampled immediately after the detection of the approaching).

When the detection signal represents that the contact of the finger with the cover member 20 is detected, an output value of the pressure-sensitive sensor 60 (that is, an output value OPₙ which is sampled simultaneously with the detection of the contact) at a point of time, at which the contact is detected, may be set as the reference value OP₀.

When the detection signal represents that the approaching of the finger to the cover member 20 in a predetermined distance is detected, an output value of the pressure-sensitive sensor 60 (that is, an output value OPₙ which is sampled simultaneously with the detection of the approaching) at a point of time, at which the approaching is detected, may be set as the reference value OP₀.

The first calculation unit 95 calculates a first pressure fₙ, which is applied to the pressure-sensitive sensor 60, in accordance with the following Expression (1). As is the case with the setting unit 94, the first calculation unit 95 also provided to each pressure-sensitive sensor 60, and calculates first pressure fₙ for each pressure-sensitive sensor 60.

fₙ=OPₙ−OP₀ (1)

The selection unit 96 selects the minimum value among four reference values OP₀ which are set by the four setting units 94, and sets, as a comparison value S₀, the minimum reference value.

The correction unit 97 calculates a correction value Rₙ of each pressure-sensitive sensor 60 in accordance with the following Expression (2) and Expression (3), and corrects first pressure fₙ of the pressure-sensitive sensor 60 by using the correction value Rₙ. As is the case with the setting unit 94 or the first calculation unit 95, the correction unit 97 is also provided for each pressure-sensitive sensor 60, and corrects the first pressure fₙ for each pressure-sensitive sensor 60. The first pressure fₙ′ in the following Expression (3) represents a first pressure after correction.

Rₙ=OP₀/S₀ (2)

fₙ′=fₙ×Rₙ (3)

Here, as illustrated in FIG. 13, the pressure-sensitive sensor 60 has the following characteristics. That is, the further a pressure increase, the smaller an increase rate of an output value becomes. Accordingly, even in the same pressure variation amount ΔF, the larger an initial load (pressing initiation load) is, the further a variation amount of the output value tends to decrease, and thus a difference in the variation amount of the output value occurs depending on the initial load.

Specifically, as illustrated in the same drawing, when pressing is initiated from a first initial load F₁ which is small, the output value of the pressure-sensitive sensor 60 varies by a first variation amount ΔV₁. In contrast, when pressing is initiated from a second initial load F₂ greater than the first initial load F₁ (F₂>F₁), a variation occurs by only a second variation amount ΔV₂, and the second variation amount ΔV₂ is narrower than the first variation amount ΔV₁. (ΔV₂<ΔV₁).

A different initial load may be applied to the four pressure-sensitive sensors 60 provided to the electronic apparatus 1 due to the posture of the electronic apparatus 1, and the like. According to the above-described reason, the first pressure fₙ, which is calculated by the first calculation unit 95, greatly depends on the initial load of each of the pressure-sensitive sensors 60.

In contrast, in the present embodiment, since the first pressure fₙ is corrected by using the correction value Rₙ to reduce an effect of the initial load with respect to the first pressure fₙ, it is possible to realize an improvement in detection accuracy of the pressure-sensitive sensor 60.

As long as the selection unit 96 select any one value among reference values OP₀ as the comparison value S₀, the selection unit 96 may select, for example, a maximum value among the reference values OP₀ as the comparison value S₀.

A method of correcting the first pressure fₙ by the selection unit 96 is not particularly limited to the above-described method as long as the further the reference value OP₀ is greater than the comparison value S₀, the larger first pressure fₙ is corrected, and the further the reference value OP₀ is smaller than the comparison value S₀, the smaller the first pressure fₙ is corrected.

The second calculation unit 98 calculates, as a second pressure Fₙ which is applied to the cover member 20, the sum of first pressures fₙ′ of the four pressure-sensitive sensors 60 after correction in accordance with the following Expression (4).

Fₙ=Σfₙ′ (4)

The sensitivity adjustment unit 99 performs sensitivity adjustment for the second pressure Fₙ in accordance with the following Expression (5). In the following expression (5), k_{adj} represents a coefficient for adjustment of an individual pressure difference of the operator, is stored in advance, for example, in a storage unit (not illustrated in the drawing) of the control device 90, and can be set by the operator in an arbitrary manner. In the following Expression (5), Fₙ′ represents a second pressure after the sensitivity adjustment.

Fₙ′=Fₙ/k_{adj} (5)

The input operation determination unit 100 determines an input operation which is intended by the operator on the basis of a position of the finger which is detected by the touch panel control unit 91, or the second pressure Fₙ′ which is detected by the pressure-sensitive sensor control unit 92.

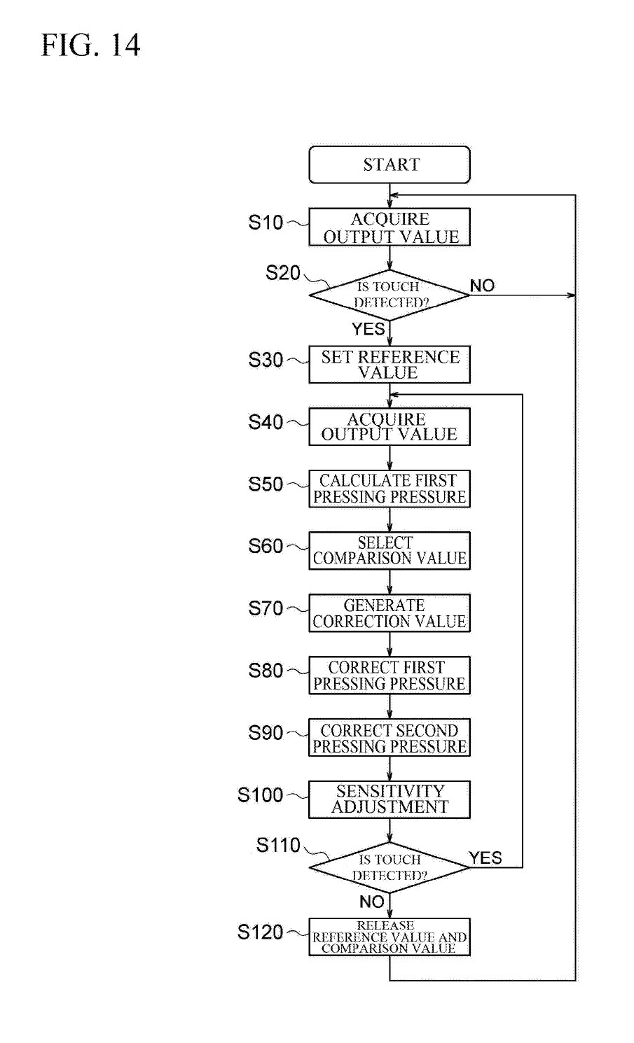

Hereinafter, description will be given of a method of detecting a pressure by using the pressure-sensitive sensor in the present embodiment with reference to FIG. 14. FIG. 14 is a flowchart illustrating the method of detecting a pressure in the present embodiment.

When control of the electronic apparatus 1 in the present embodiment is initiated, first, in step S10 of FIG. 14, the acquisition unit 93 acquires an output of the four pressure-sensitive sensors 60, and output the output value OPₙ to the setting unit 94 and the first calculation unit 95. Then, in step S20, the setting unit 94 determines whether or not a detection signal is input from the touch panel control unit 91.

As long as contact of the finger of the operation with the cover member 20 is not detected by the touch panel control unit 91 (NO in step S20 of FIG. 14), step S10 to Step S20 are repetitively executed at a constant interval.

On the other hand, when the contact of the finger is detected by the touch panel control unit 91 (YES in step S20 of FIG. 14), in step S30 of FIG. 14, the setting unit 94 sets, as the reference value OP₀, an output value OPₙ which is sampled immediately before detecting the contact. The reference value OP₀ is set for each pressure-sensitive sensor 60, and thus four reference values OP₀ are set in the present embodiment.

When each of the reference values OP₀ is set, in step S40 of FIG. 14, the acquisition unit 93 acquires the output value OPₙ of the pressure-sensitive sensor 60, and in step S50 of FIG. 14, the first calculation unit 95 calculates the first pressure fₙ from the output value OPₙ and the reference value OP₀ in accordance with Expression (1). The first pressure fₙ is also set for each pressure-sensitive sensor 60.

Next, in step S60 of FIG. 14, the selection unit 96 sets, as the comparison value S₀, the minimum value among the four reference values OP₀.

Next, in step S70 of FIG. 14, the correction unit 97 calculates the correction value Rₙ of each pressure-sensitive sensor 60 in accordance with Expression (2), and in step S80 of FIG. 14, the correction unit 97 corrects the first pressure fₙ by using the correction value Rₙ in accordance with Expression (3). The correction value Rₙ is also set for each pressure-sensitive sensor 60.

Next, in step S90 of FIG. 14, the second calculation unit 98 calculates the sum of the first pressure fₙ′ of the four pressure-sensitive sensors 60 after correction to obtain the second pressure Fₙ in accordance with Expression (4).

Next, in step S100 of FIG. 14, the sensitivity adjustment unit 99 performs sensitivity adjustment of the second pressure Fₙ in accordance with Expression (5). The second pressure Fₙ′ after adjustment is output to the input operation determination unit 100, and the input operation determination unit 100 determines an input operation, which is performed by the operator with respect to the electronic apparatus 1, on the basis of the second pressure Fₙ′ after the adjustment. The step S100 may be omitted, and in this case, the second pressure Fₙ which is calculated in step S90 is output to the input operation determination unit 100.

As long as the contact of the finger continues (YES in step S110 of FIG. 14), the above-described steps S40 to S100 repetitively executed at a constant interval. The step S60 is executed only at a first time after the detection signal is input from the touch panel control unit 91.

In contrast, when the contact of the finger is not detected by the touch panel control unit 91 (NO in step S110 of FIG. 14), in step S120 of FIG. 14, the setting of the four reference values OP₀ and the comparison value S₀ is released, and the process returns to step S10 of FIG. 14.

As described above, in the present embodiment, since a difference between the output value OPₙ of the pressure-sensitive sensor 60 and the reference value OP₀ is calculated as the first pressure fₙ, it is possible to cancel an effect due to the posture of the electronic apparatus 1 and the like, and it is possible to realize an improvement in pressure detection accuracy by the pressure-sensitive sensor 60.

The above-described embodiment is described for easy understanding of the invention, and is not intended to limit the invention. Accordingly, respective elements, which are disclosed in the above-described embodiment, are intended to include all design modifications or equivalents thereof which pertain to the technical scope of the invention.

For example, the second pressure Fₙ may be calculated by calculating the sum of the first pressure fₙ, which is calculated by the first calculation unit 95, instead of the first pressure fₙ′ after correction.

The first pressure fₙ′ after correction may be output to the input operation determination unit 100 instead of the second pressure Fₙ, and the input operation determination unit 100 may determine the input operation on the basis of the first pressure fₙ′ after correction.

Alternatively, the first pressure fₙ may be output to the input operation determination unit 100 instead of the second pressure Fₙ, and the input operation determination unit 100 may determine the input operation on the basis of the first pressure fₙ.

In the above-described embodiment, the pressure-sensitive sensors 60 are disposed at four corners of the electronic apparatus 1, but there is no particular limitation thereto. For example, in a case where the pressure-sensitive sensor is constituted by using an electrostatic capacitance type sensor, the pressure-sensitive sensor may be constituted by a sheet-shaped electrostatic capacitive sensor, and a transparent elastic member which is provided on the electrostatic capacitive sensor, and the pressure-sensitive sensor may be interposed between the touch panel 40 and the display device 50 with the transparent elastic member disposed on a touch panel 40 side. The pressure-sensitive sensor has substantially the same size as the touch panel 40, and is laid on the entirety of the rear surface of the touch panel 40. In the electrostatic capacitive sensor, a plurality of detection regions are divided, and the pressure-sensitive sensor control unit 92 of the control device 90 acquires a detection result from the plurality of detection regions.

### EXPLANATIONS OF LETTERS OR NUMERALS

1: Electronic apparatus
10, 10C: Movable unit
20: Cover member
30: Reinforcing member
40: Touch panel
50: Display device
60: Pressure-sensitive sensor
70: Seal member
80: Support member
90: Control device
91: Touch panel control unit
92: Pressure-sensitive sensor control unit
93: Acquisition unit
94: Setting unit
95: First calculation unit
96: Selection unit
97: Correction unit
98: Second calculation unit
99: Sensitivity adjustment unit
100: Input operation determination unit

1. An electronic apparatus comprising:
a cover member including a transparent portion;
a touch panel on which the cover member is laid;
a display unit which includes a display region which faces the transparent portion through the touch panel;
pressure-sensitive sensors which deform in accordance with pressing of the cover member; and
a control unit which is electrically connected to the touch panel and the pressure-sensitive sensor,
wherein the control unit includes:
a detection unit which outputs a detection signal on the basis of an output value of the touch panel;
a setting unit which sets, as a reference value, an output value of the pressure-sensitive sensor at a predetermined timing in a case where the detection signal is input from the detection unit; and
a first calculation unit which calculates, as a first pressure which is applied to the pressure-sensitive sensor, a difference between an output value of the pressure-sensitive sensor after the predetermined timing and the reference value,
the setting unit individually sets the reference value with respect to each of the pressure-sensitive sensors,
the first calculation unit individually calculates the first pressure with respect to each of the pressure-sensitive sensors each time the output value of each of the pressure-sensitive sensors is input,
the detection signal is a signal which represents that contact of an object to be detected with the cover member is detected, and
the predetermined timing is a point of time immediately before detecting the contact of the object or a point of time at which the contact of the object is detected.

2. An electronic apparatus comprising:
a cover member including a transparent portion;
a touch panel on which the cover member is laid;
a display unit which includes a display region which faces the transparent portion through the touch panel;
pressure-sensitive sensors which deform in accordance with pressing of the cover member; and
a control unit which is electrically connected to the touch panel and the pressure-sensitive sensor,
wherein the control unit includes:
a detection unit which outputs a detection signal on the basis of an output value of the touch panel;
a setting unit which sets, as a reference value, an output value of the pressure-sensitive sensor at a predetermined timing in a case where the detection signal is input from the detection unit; and
a first calculation unit which calculates, as a first pressure which is applied to the pressure-sensitive sensor, a difference between an output value of the pressure-sensitive sensor after the predetermined timing and the reference value,
the setting unit individually sets the reference value with respect to each of the pressure-sensitive sensors,
the first calculation unit individually calculates the first pressure with respect to each of the pressure-sensitive sensors each time the output value of each of the pressure-sensitive sensors is input,
the detection signal is a signal which represents that approaching of an object to be detected to the cover member in a predetermined distance is detected, and
the predetermined timing is a point of time at which the approaching of the object is detected or a point of time immediately after detecting the approaching of the object.

3. An electronic apparatus comprising:
a cover member including a transparent portion;
a touch panel on which the cover member is laid;
a display unit which includes a display region which faces the transparent portion through the touch panel;
pressure-sensitive sensors which deform in accordance with pressing of the cover member; and
a control unit which is electrically connected to the touch panel and the pressure-sensitive sensor,
wherein the control unit includes,
a detection unit which outputs a detection signal on the basis of an output value of the touch panel,
a setting unit which sets, as a reference value, an output value of the pressure-sensitive sensor at a predetermined timing in a case where the detection signal is input from the detection unit, and
a first calculation unit which calculates, as a first pressure which is applied to the pressure-sensitive sensor, a difference between an output value of the pressure-sensitive sensor after the predetermined timing and the reference value,
the setting unit individually sets the reference value with respect to each of the pressure-sensitive sensors,
the first calculation unit individually calculates the first pressure with respect to each of the pressure-sensitive sensors each time the output value of each of the pressure-sensitive sensors is input, and
the control unit further includes:
a selection unit which selects, as a comparison value, any one of the reference values; and
a correction unit which corrects the first pressure on the basis of the comparison value and the reference value.

4. The electronic apparatus according to claim 1, wherein
the control unit further includes a second calculation unit which calculates, as a second pressure which is applied to the cover member, the sum of the first pressures.

5. A method of controlling an electronic apparatus including a cover member including a transparent portion, a touch panel on which the cover member is laid, a display unit which includes a display region which faces the transparent portion through the touch panel, and pressure-sensitive sensors which deform in accordance with pressing of the cover member, the method comprising:
(a) detecting contact of an object to be detected with the cover member or approaching of the object to the cover member on the basis of an output value of the touch panel;
(b) setting, as a reference value, an output value of the pressure-sensitive sensor at a predetermined timing in a case where the contact or the approaching of the object is detected; and
(c) calculating, as a first pressure which is applied to the pressure-sensitive sensor, a difference between an output value of the pressure-sensitive sensor after the predetermined timing and the reference value,
wherein the (b) setting includes individually setting the reference value with respect to each of the pressure-sensitive sensors,
the (c) calculating includes individually calculating the first pressure with respect to each of the pressure-sensitive sensors each time the output value of each of the pressure-sensitive sensors is input,
the (a) detecting includes detecting the contact of the object with the cover member, and
the predetermined timing is a point of time immediately before detecting the contact of the object or a point of time at which the contact of the object is detected.

6. A method of controlling an electronic apparatus including a cover member including a transparent portion, a touch panel on which the cover member is laid, a display unit which includes a display region which faces the transparent portion through the touch panel, and pressure-sensitive sensors which deform in accordance with pressing of the cover member, the method comprising:
(a) detecting contact of an object to be detected with the cover member or approaching of the object to the cover member on the basis of an output value of the touch panel;
(b) setting, as a reference value, an output value of the pressure-sensitive sensor at a predetermined timing in a case where the contact or the approaching of the object is detected; and
(c) calculating, as a first pressure which is applied to the pressure-sensitive sensor, a difference between an output value of the pressure-sensitive sensor after the predetermined timing and the reference value,
wherein the (b) setting includes individually setting the reference value with respect to each of the pressure-sensitive sensors,
the (c) calculating includes individually calculating the first pressure with respect to each of the pressure-sensitive sensors each time the output value of each of the pressure-sensitive sensors is input,
the (a) detecting includes detecting the approaching of the object to the cover member in a predetermined distance, and
the predetermined timing is a point of time at which the approaching of the object is detected or a point of time immediately after detecting the approaching of the object.

7. A method of controlling an electronic apparatus including a cover member including a transparent portion, a touch panel on which the cover member is laid, a display unit which includes a display region which faces the transparent portion through the touch panel, and pressure-sensitive sensors which deform in accordance with pressing of the cover member, the method comprising:
(a) detecting contact of an object to be detected with the cover member or approaching of the object to the cover member on the basis of an output value of the touch panel;
(b) setting, as a reference value, an output value of the pressure-sensitive sensor at a predetermined timing in a case where the contact or the approaching of the object is detected; and
(c) calculating, as a first pressure which is applied to the pressure-sensitive sensor, a difference between an output value of the pressure-sensitive sensor after the predetermined timing and the reference value,
wherein the (b) setting includes individually setting the reference value with respect to each of the pressure-sensitive sensors,
the (c) calculating includes individually calculating the first pressure with respect to each of the pressure-sensitive sensors each time the output value of each of the pressure-sensitive sensors is input, and
the method further comprises:
(d) selecting, as a comparison value, any one of the reference values; and
(e) correcting the first pressure on the basis of the comparison value and the reference value.

8. The method of controlling an electronic apparatus according to claim 5, further comprising:
(f) calculating, as a second pressure which is applied to the cover member, the sum of the first pressures.

9. The electronic apparatus according to claim 2, wherein
the control unit further includes a second calculation unit which calculates, as a second pressure which is applied to the cover member, the sum of the first pressures.

10. The electronic apparatus according to claim 3, wherein
the control unit further includes a second calculation unit which calculates, as a second pressure which is applied to the cover member, the sum of the first pressures.

11. The method of controlling an electronic apparatus according to claim 6, further comprising:
(f) calculating, as a second pressure which is applied to the cover member, the sum of the first pressures.

12. The method of controlling an electronic apparatus according to claim 5, further comprising:
(f) calculating, as a second pressure which is applied to the cover member, the sum of the first pressures.
